(19) United States
(12) Patent Application Publication
(10) Pub. No.: US 2008/0307241 A1
(43) Pub. Date: Dec. 11, 2008

(54) Microcontroller circuit and power saving method thereof

(76) Inventors: Eric Lin, Jhongli City (TW); Wen-Chi Hsu, Lugang Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/808,279

(22) Filed: Jun. 8, 2007

(51) Int. Cl. G06F 1/28; G06F 1/26

(52) U.S. Cl. 713/320

(57) ABSTRACT

A microcontroller circuit provides proper clocks to a central processing unit of a microcontroller and peripherals according to a power saving mode and operating conditions of the peripherals. The microcontroller circuit comprises a prescaler, a second multiplexer, a central processing unit, a first switch, a second switch, a first peripheral, and an execution unit. The execution unit is installed in the central processing unit and used for controlling the first switch and the second switch. The switches control the transmission of clocks according to the power saving mode operated by the microcontroller circuit, so that the central processing unit and each peripheral can work with a proper clock to reduce power use.

### BACKGROUND OF THE INVENTION

1. Field of the Invention

The present invention relates to a microcontroller circuit and a power saving method thereof, and more particularly to a circuit and a method of controlling and allocating clocks of a microcontroller.

2. Description of Related Art

A general power management mechanism for microcontrollers controls the speed of a system clock to reduce power use. U.S. Pat. Application No. US2003/0079152 entitled “Microprocessor having multiple power saving modes and simulator thereof” disclosed a technology for controlling power consumption of a microprocessor via a selected clock.

Please refer to FIG. 1, in which a circuit block diagram of a conventional microprocessor is shown. A selecting unit 150 comprises four selecting input terminals. One of the input terminals receives an output 151 of a divider 180, another input terminal 152 is coupled directly to ground, another input terminal receives a main system clock 153 generated by an oscillator 190, and a final input terminal receives an output signal 154 of an internal RC oscillator 170. Similarly, the selecting unit 160 also includes four selecting input terminals. One of the input terminals receives an output 151 of a divider 180, another input terminal 155 is coupled directly to ground, and another input terminal receives a main system clock 153 generated by an oscillator 190, and a final input terminal receives an output signal 154 generated by an internal RC oscillator 170. The output 151 of the divider 180 is generated by another clock of a low power oscillator 191 and fed back to the divider 180. The clock is processed by the divider 180 and then outputted to both selecting units 150, 160. The central processing unit 100 can be operated in different power saving modes. An execution unit 101 is provided for controlling the selecting units 150, 160, such that the selecting units 150, 160 select one of the four input clocks, and send the selected clock separately to the central processing unit 100 and peripherals 120, 130.

In U.S. Pat. Application No. 2003/0079152a, the clocks required by the central processing unit 100 and peripherals 120, 130 are selected by the two selecting units 150,160 and one of the four clocks is fed back. In a different operating mode, corresponding clocks are selected for the operation of the central processing unit 100 and peripherals 120, 130 to control the power consumption of a microcontroller.

### SUMMARY OF THE INVENTION

In view of the foregoing shortcomings, the present invention provides a microcontroller circuit and a power saving method that switches to one of the power saving modes and controls a switch to a clock that reduces the power use of a central processing unit and peripherals.

The present invention provides a microcontroller comprising: a prescaler for receiving a first clock and outputting a plurality of second clocks after dividing the frequency of the first clock; a second multiplexer for receiving a third clock, the first clock and the second clocks, and outputting a fourth clock; a central processing unit for receiving the fourth clock; a first switch installed between the central processing unit and the second multiplexer, wherein the fourth clock is transmitted to the central processing unit through the first switch; a second switch; a first peripheral for receiving the third clock through the second switch; and an execution unit installed in the central processing unit for controlling the first switch and the second switch based on a power saving mode operated by the microcontroller.

The present invention provides a power saving method for a microcontroller, and the method comprises the steps of providing a first clock and a third clock; outputting a plurality of second clocks after dividing the frequency of the first clock; setting a low power register to select a power saving mode; controlling a first switch to enable or disable the first clock to input one of the second clocks or the third clock to a central processing unit of the microcontroller; and controlling a second switch to enable or disable the third clock to be inputted to a first peripheral.

To make it easier for our examiner to understand the innovative features and technical content, we use preferred embodiments together with the attached drawings for the detailed description of the invention, but it should be pointed out that the attached drawings are provided for reference and description but not for limiting the present invention.

### BRIEF DESCRIPTION OF THE DRAWINGS

FIG. 1 is a circuit block diagram of a conventional microprocessor;

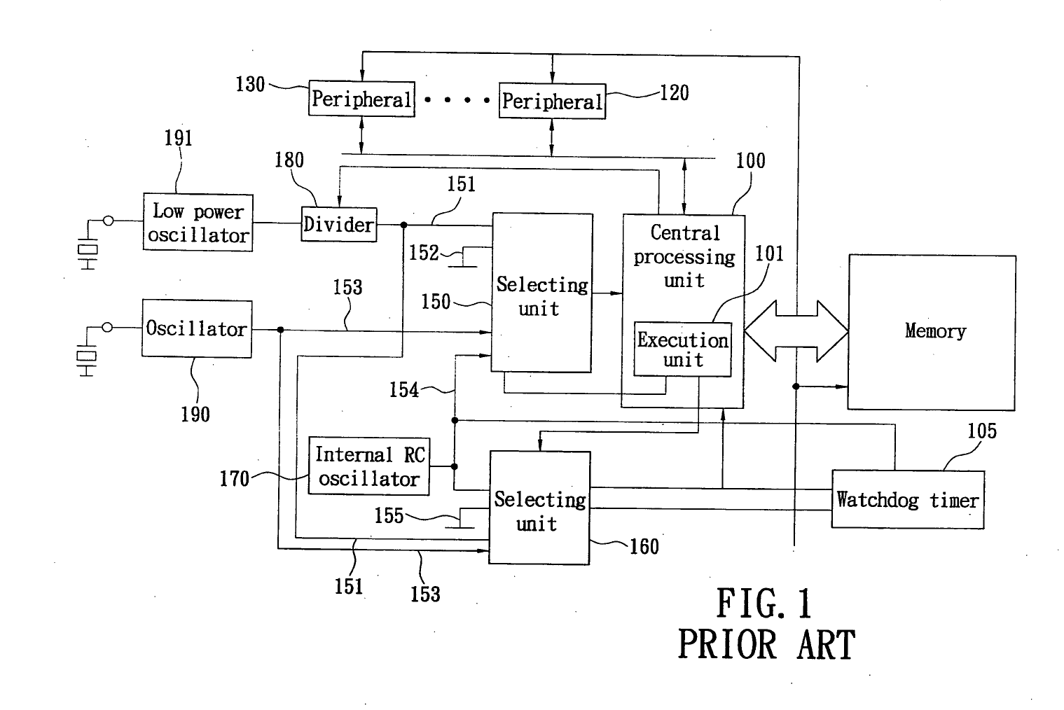

FIG. 2 is a circuit block diagram of a microcontroller circuit of the present invention;

FIG. 3 shows the status of a power saving mode of the present invention; and

FIG. 4 is a flow chart of a power saving method for a microcontroller of the present invention.

### DETAILED DESCRIPTION OF THE PREFERRED EMBODIMENTS

In general, the power use of a microcontroller can be reduced by a method of controlling the clocks of a central processing unit in the microcontroller and the peripherals. The present invention provides an improved clock control and improved allocation mechanism to reduce the power usage of a microcontroller.

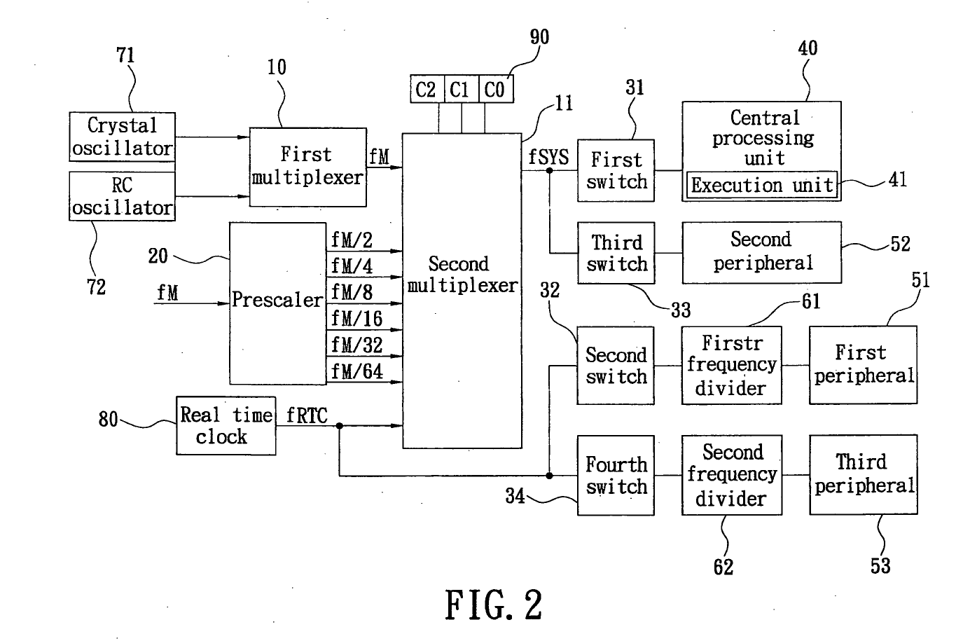

Please refer to FIG. 2, which is a circuit block diagram of a microcontroller circuit of the present invention. A crystal oscillator 71, an RC oscillator 72, and a real time clock (RTC) 80 provide a first clock fM and a third clock fRTC. The first clock fM is an external clock of the crystal oscillator 71 and the RC oscillator 72 transferred to the first multiplexer 10. The first multiplexer 10 controls and selects the generation of one of the clocks. However, the first multiplexer 10 sends the first clock fM of the output to the second multiplexer 11 and the prescaler 20. After the prescaler 20 receives the first clock fM, the frequency of the first clock fM is divided to produce a plurality of second clocks fM/2, fM/4, fM/8, fM/16, fM/32, fM/64), and these second clocks fM/2, fM/4, fM/8, fM/16, fM/32 and fM/640 are outputted to the second multiplexer 11. The second multiplexer 11 receives the first clock fM and the second clocks fM/2, fM/4, fM/8, fM/16, fM/32, fM/64, and also receives the third clock fRTC provided by the real time clock 80. The second multiplexer 11 has a total of eight input terminals for receiving eight clocks, and thus the second multiplexer 11 can select a clock via a select control bit C0, C1, C2 of a register 90 and output a fourth clock fSYS (wherein the second multiplexer 11 of this embodiment has eight input signals, and thus the register 90 uses three bits for the selection). The required number of bits of the register 90 can be selected according to the number of inputs of the second multiplexer 11 as needed in practical application. The select/ing control/ing bits C0, C1, C2 of the register 90 are set by an execution unit 41 of the central processing unit 40 based on the power saving mode for outputting the fourth clock fSYS to the central processing unit 40 and the second peripheral 52.

Furthermore, a first switch 31 is installed between the central processing unit 40 and the second multiplexer 11, and a third switch 33 is installed between the second peripheral 52 and the second multiplexer 11. The first switch 31 is controlled by the execution unit 41 based on the power saving mode, and the third switch 33 is controlled by the execution unit 41 based on the power saving mode and a switch control bit set by the second peripheral 52 to control the fourth clock fSYS to be transmitted to the central processing unit 40 and the second peripheral 52. The switch control bit set by the second peripheral 52 is a bit that indicates whether or not the second peripheral 52 is operating. The second peripheral 52 can be a digital-to-analog converter or a pulse width modulator. The method for the execution unit 41 to execute, control and set up based on the power saving mode is described below.

The third clock fRTC provided by the real time clock 80 is transmitted to the second multiplexer 11 as well as other peripherals. As shown in the figure, the third clock fRTC is inputted to the first peripheral 51 through the second switch 32 and the first frequency divider 61, and also inputted to the third peripheral 53 through the fourth switch 34 and the second frequency divider 62. The second switch 32 is controlled by the execution unit 41 based on the power saving mode and a switch control bit of the first peripheral 51. The fourth switch 34 is controlled by the execution unit 41 based on the power saving mode. Similarly, the switch control bit set by the first peripheral 51 is a bit indicating whether or not the first peripheral 51 is operating. Further, the first frequency divider 61 is provided for dividing the third clock fRTC into a clock required for the operation of the first peripheral 51 and the clock is transmitted to the first peripheral 51. Similarly, the second frequency divider 62 is provided for dividing the third clock fRTC into a clock required for the operation of the third peripheral 53, and the clock is transmitted to the third peripheral 53. The first peripheral 51 can be a device such as a liquid crystal display (LCD) and the third peripheral 53 can be a circuit such as a watchdog timer (WDT), a real time clock (RTC) interrupter or a buzzer.

From the foregoing circuit block diagram, the clocks for the central processing unit 40 and the second peripheral 52 are set by the execution unit 41 for controlling the second multiplexer 11, the first switch 31, and the third switch 33 to provide a better clock selected from a plurality of clocks. The clocks for the first peripheral 51 and the third peripheral 53 are the third clock fRTC provided by the real time clock 80 only, and controlled by the second switch 32 and the fourth switch 34 to determine whether or not to provide the third clock fRTC. The first frequency divider 61 and the second frequency divider 62 are provided for processing the third clock fRTC to provide an appropriate clock to the first peripheral 51 and the third peripheral 53. Similarly, the circuit architecture of the present invention further installs a switch and a frequency divider to be applied in many peripherals other than those described in this embodiment.

The power saving modes of the present invention can be switched by setting a low power register (not shown in the figure). The power saving modes include a normal mode, a slow mode, an idle mode, and a sleep mode. The operating characteristic of each mode is used for controlling the selection of each switch and clock to achieve the power saving effect of the microcontroller.

The first switch 31, second switch 32, third switch 33, and fourth switch 34 are provided for enabling or disabling a clock. The switches are controlled to be turned on or off by the execution unit 41 based on the power saving mode and a switch control bit of each corresponding peripheral. The principle of operating the switches is described one by one below.

The first switch 31 is installed between the central processing unit 40 and the second multiplexer 11. In normal mode or slow mode, the central processing unit 40 must receive a fourth clock fSYS for its operations, such that if the microcontroller is operated in normal mode or slow mode, the execution unit 41 controls the first switch 31 to an ON state, and thus the fourth clock fSYS is inputted to the central processing unit 40 through the first switch 31 and provided for the operation of the central processing unit 40. In sleep mode or idle mode, the central processing unit 40 is turned off to save power. If the microcontroller is operated at sleep mode or idle mode, the execution unit 41 controls the first switch 31 to an OFF state to stop supplying the fourth clock fSYS to the central processing unit 40.

The second switch 32 is installed between the real time clock 80 and the first frequency divider 61. The third clock fRTC provided by the real time clock 80 is passed through the second switch 32. The frequency of the third clock fRTC is divided by the first frequency divider 61 and transmitted to the first peripheral 51. The determination conditions for the execution unit 41 to control the second switch 32 to an ON state include the microcontroller not being operated in a sleep mode and the first peripheral 51 being in an operating state. If the foregoing conditions are satisfied, then the execution unit 41 will control the second switch 32 to remain in an ON state, and the first frequency divider 61 will divide the frequency of the third clock fRTC to be supplied to the first peripheral 51. The first peripheral 51 is determined to be in an operating state, and a switch control bit of the first peripheral 51 is provided for the determination. The switch control bit is a bit that indicates whether the first peripheral 51 is in an operating state or a non-operating state. On the other hand, if the microcontroller is in sleep mode and the first peripheral 51 is in a non-operating state, then the execution unit 41 will control the second switch 32 to an OFF state and stop providing the third clock fRTC to the first peripheral 51.

The third switch 33 is installed between the second peripheral 52 and the second multiplexer 11. The determination conditions for the execution unit 41 to control the third switch 33 in an ON state include the microcontroller being in a normal mode or a slow mode and the second peripheral 52 being in an operating state. If the foregoing conditions are satisfied, the execution unit 41 will control the third switch 33 in an ON state and transmit the fourth clock fSYS to the second peripheral 52 for the operation of the second peripheral 52. If the microcontroller is in a sleep mode or an idle mode or the second peripheral 52 is in a non-operating state, the execution unit 41 will control the third switch 33 to an OFF state to stop providing the fourth clock fSYS to the second peripheral 52. The operating state of the second peripheral 52 can be determined by the principle as described above. A switch control bit of the second peripheral 52 is used for the determination. The switch control bit is a bit indicating whether the second peripheral 52 is in an operating state or a non-operating state.

The fourth switch 34 is installed between the real time clock 80 and the second frequency divider 62. The third clock fRTC provided by the real time clock 80 is passed through the fourth switch 34. The frequency of the third clock fRTC is divided by the second frequency divider 62. The clock is transmitted to the third peripheral 53. If the microcontroller is not in a sleep mode, then the fourth switch 34 will be controlled in an ON state by the execution unit 41, and the frequency of the third clock fRTC will be divided by the second frequency divider 62 and provided for the second peripheral 52. If the microcontroller is in a sleep mode, then the fourth switch 34 will be controlled in an OFF state by the execution unit 41 to stop providing the third clock fRTC to the third peripheral 53.

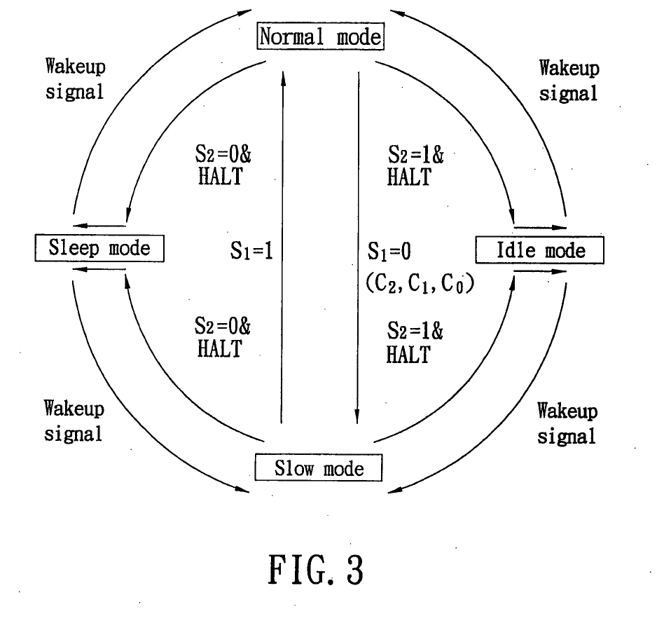

Please refer to FIG. 3 for the status of a power saving mode of the present invention. A preferred embodiment is used for illustrating the switching of the power saving modes by using a reset signal and setting a firmware bit. The power saving modes of the invention include a normal mode, a slow mode, an idle mode, and a sleep mode. The modes can be switched by executing an instruction of the power saving mode to set a low power register. In other words, a firmware bit is set for switching the power saving modes. The microcontroller switches between a normal mode and a slow mode by setting a first firmware control bit S1. In the slow mode and normal mode, the execution unit 41 must set the select control bit C0, C1, C2 of the register 90 for selecting a clock from the first clock fM, the second clocks fM/2, fM/4, fM/8, fM/16, fM/32, fM/64 and the third clock fRTC, such that the second multiplexer 11 can output a fourth clock fSYS. The select control bit C0, C1, C2 is set to determine whether the fourth clock fSYS is the first clock fM, one of the second clocks fM/2, fM/4, fM/8, fM/16, fM/32, fM/64 or the third clock fRTC.

If the microcontroller is switched from a normal mode to a slow mode, the first firmware control bit S1 will be set to 0, and the select control bit C0, C1, C2 will be set. For example, if the select control bit C0, C1, C2 is set to 111, and the fourth clock fSYS will be equal to fM/2; if the select control bit C0, C1, C2 is set to 000, then the fourth clock fSYS will be the third clock fRTC, and so on. Therefore, the central processing unit 40 and the second peripheral 52 can be operated at a more appropriate speed to reduce power consumption. If the microcontroller is switched from a slow mode to a normal mode, the first firmware control bit S1 will be set to 1, and the fourth clock fSYS outputted by the second multiplexer 11 output is the first clock fM. The fourth clock fSYS (which is the first clock fM by then) will be transmitted to the central processing unit 40 and the second peripheral 52 through the first switch 31 and the third switch 33 for the operation of the central processing unit 40 and the second peripheral 52.

Switching between normal mode and sleep mode, and between normal mode and idle mode, can be achieved by setting a second firmware control bit S2 and a halt command, and using a wakeup signal. For example, the second firmware control bit S2 is set to 0 and the halt command is inputted, this switches the microcontroller from normal mode to sleep mode. If the wakeup signal is used in sleep mode, the microcontroller will return to the normal mode from the sleep mode. If the second firmware control bit S2 is set to 1 and the halt command is inputted, then the microcontroller will be switched from normal mode to idle mode. If the wakeup signal is used in idle mode, then the microcontroller will return to the normal mode from the idle mode.

Similarly, switching between slow mode and sleep mode, and between slow mode and idle mode, can be achieved by setting a second firmware control bit S2 and a halt command, and using a wakeup signal. For example, the second firmware control bit S2 is set to 0 and a halt command is inputted, this switches the microcontroller from slow mode to sleep mode. If the wakeup signal is used in sleep mode, the microcontroller will return to the slow mode from the sleep mode. If the second firmware control bit S2 is set to 1 and a halt command is inputted, then the microcontroller will be switched from slow mode to idle mode. If the wakeup signal is used in idle mode, then the microcontroller will return to slow mode from idle mode.

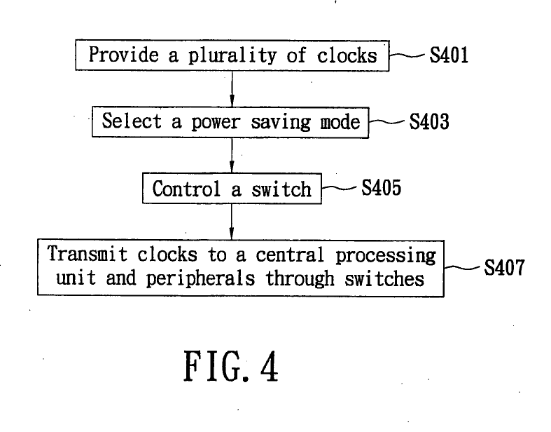

Please refer to FIG. 4, which is a flow chart of a power saving method for a microcontroller in accordance with the present invention. The crystal oscillator 71 or RC oscillator 72 provides the first clock fM, the real time clock 80 provides the third clock fRTC, and the prescaler 20 divides the first clock fM into a plurality of second clocks fM/2, fM/4, fM/8, fM/16, fM/32, fM/64 to be transmitted to the second multiplexer 11 (as shown in Step S401). The microcontroller sets a first firmware control bit S1 and a second firmware control bit S2 of a low power register via the instruction of a power saving mode to select normal mode, slow mode, idle mode or sleep mode (as shown in Step S403). The execution unit 41 of the central processing unit 40 controls each switch based on the power saving mode and a switch control bit of the peripheral (as shown in Step S405). Finally, the central processing unit 40 and peripherals receive the clock from each switch based on a different power saving mode for their operation, so as to reduce power consumption (as shown in Step S407).

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A microcontroller, comprising:
a prescaler, for receiving a first clock, and outputting a plurality of second clocks after dividing the frequency of said first clock;
a second multiplexer, for receiving a third clock, said first clock, and said second clocks, and outputting a fourth clock;
a central processing unit, for receiving said fourth clock;
a first switch, installed between said central processing unit and said second multiplexer;
a second switch; and
a first peripheral, for receiving said third clock through said second switch;
thereby said central processing unit controls said first switch and said second switch based on a power saving mode operated by said microcontroller.

2. The microcontroller of claim 1, further comprising a first multiplexer for receiving an external clock to output said first clock.

3. The microcontroller of claim 2, wherein said external clock includes a clock provided by an RC oscillator and a clock provided by a crystal oscillator.

4. The microcontroller of claim 1, wherein said second clock is a clock equal to said first clock divided by 2, 4, 8, 16, 32 or 64.

5. The microcontroller of claim 1, further comprising a register, such that a plurality of select control bits of said register is used for determining whether or not to output said fourth clock by said second multiplexer.

6. The microcontroller of claim 5, wherein said select control bit is set by said execution unit based on said power saving mode for determining whether or not to output said fourth clock.

7. The microcontroller of claim 1, wherein said third clock is a clock provided by a real time clock (RTC).

8. The microcontroller of claim 1, further comprising a first frequency divider installed between said first peripheral and said second switch.

9. The microcontroller of claim 1, wherein said central processing unit further comprising an execution unit for controlling said first switch and said second switch based on said power saving mode.

10. The microcontroller of claim 9, wherein said first peripheral has a switch control bit set for said execution unit to control said second switch based on said power saving mode and said switch control unit.

11. The microcontroller of claim 1, wherein said power saving modes include a normal mode, a slow mode, an idle mode, and a sleep mode.

12. The microcontroller of claim 11, further comprising a low power register for switching said power saving modes by setting said low power register.

13. The microcontroller of claim 1, further comprising a second peripheral for receiving said fourth clock through an output of said second multiplexer connected to a third switch.

14. The microcontroller of claim 13, wherein said second peripheral includes a digital-to-analog converter or a pulse width modulator.

15. The microcontroller of claim 13, wherein said second peripheral has a switch control bit provided for said execution unit to control said third switch based on said power saving mode and said switch control unit.

16. The microcontroller of claim 1, further comprising a third peripheral for receiving said third clock through a fourth switch.

17. The microcontroller of claim 16, further comprising a second frequency divider installed between said third peripheral and said fourth switch.

18. The microcontroller of claim 16, wherein said third peripheral includes a watchdog timer, a real time clock interrupter or a buzzer.

19. A power saving method for a microcontroller, comprising the steps of:
providing a first clock and a third clock;
dividing the frequency of said first clock, and then outputting a plurality of second clocks;
selecting a power saving mode;
controlling a first switch to enable or disable said first clock, one of said second clocks or said third clock to be inputted to a central processing unit of said microcontroller; and
controlling a second switch to enable or disable said third clock to be inputted to a first peripheral.

20. The power saving method for a microcontroller of claim 19, wherein said first switch is controlled by an execution unit based on said power saving mode.

21. The power saving method for a microcontroller of claim 19, wherein said second switch is controlled by an execution unit based on said power saving mode and a switch control bit of said first peripheral.

22. The power saving method for a microcontroller of claim 19, wherein said first clock is a clock provided by an RC oscillator or a crystal oscillator.

23. The power saving method for a microcontroller of claim 19, wherein said third clock is provided by a real time clock (RTC).

24. The power saving method for a microcontroller of claim 19, wherein said first clock, one of said second clocks or said third clock is determined by a second multiplexer to be outputted to said central processing unit based on a select control bit of said register.

25. The power saving method for a microcontroller of claim 19, wherein said third clock has its frequency divided by a first frequency divider and then said third clock is transmitted to said first peripheral.

26. The power saving method for a microcontroller of claim 19, wherein said power saving modes include a normal mode, a slow mode, an idle mode, and a sleep mode.

27. The power saving method for a microcontroller of claim 26, wherein said power saving modes are switched by setting a low power register.

28. The power saving method for a microcontroller of claim 27, wherein said normal mode and said slow mode are switched by setting a first firmware control bit of said low power register.

29. The power saving method for a microcontroller of claim 27, wherein said normal mode and said sleep mode, said normal mode and said idle mode, said slow mode and sleep mode, and said slow mode and said idle mode are switched by setting a second firmware control bit of said low power register and a halt command.

30. The power saving method for a microcontroller of claim 26, wherein said sleep mode and said idle mode start a wakeup mechanism by a wakeup signal to return to said normal mode or said slow mode.

31. The power saving method for a microcontroller of claim 19, further comprising a step of transmitting said first clock, one of said second clocks or one of said third clock to a second peripheral through a third switch.

32. The power saving method for a microcontroller of claim 31, wherein said third switch is controlled by an execution unit based on said power saving mode and a switch control bit of said second peripheral.

33. The power saving method for a microcontroller of claim 19, further comprising a step of transmitting said third clock to a third peripheral through a fourth switch.

34. The power saving method for a microcontroller of claim 33, wherein said third clock has its frequency divided by a second frequency divider, and said third clock is transmitted to said third peripheral.

35. The power saving method for a microcontroller of claim 33, wherein said fourth switch is controlled by an execution unit based on said power saving mode.

36. A power saving method for a microcontroller, comprising the steps of:
providing a first clock and a third clock;
providing a prescaler to divide the frequency of said first clock, and
outputting a plurality of second clocks;
switching said microcontroller to a power saving mode;
providing a second multiplexer, for receiving said first clock, said second clock and said third clock, and outputting a fourth clock based on a select control bit of a register, and said select control bit of said register being set according to said power saving mode;
controlling a first switch to enable or disable said fourth clock to be inputted to a central processing unit of said microcontroller; and
controlling a second switch to enable or disable said third clock to be inputted a first peripheral.

37. The power saving method for a microcontroller of claim 36, wherein said first switch is controlled by an execution unit based on said power saving mode.

38. The power saving method for a microcontroller of claim 36, wherein said second switch is controlled by an execution unit based on said power saving mode and a switch control bit of said first peripheral.

39. The power saving method for a microcontroller of claim 36, wherein said select control bit of said register is set by an execution unit based on said power saving mode.

40. The power saving method for a microcontroller of claim 36, wherein said first clock is a clock provided by an RC oscillator or a crystal oscillator.

41. The power saving method for a microcontroller of claim 36, wherein said third clock is provided by a real time clock (RTC).

42. The power saving method for a microcontroller of claim 36, wherein said third clock has its frequency divided by a first frequency divider, and then said third clock is transmitted to said first peripheral.

43. The power saving method for a microcontroller of claim 36, wherein said power saving mode includes a normal mode, a slow mode, an idle mode, and a sleep mode.

44. The power saving method for a microcontroller of claim 43, wherein said power saving mode is switched by a low power register.

45. The power saving method for a microcontroller of claim 44, wherein said normal mode and said slow mode are switched by setting a first firmware control bit of said low power register.

46. The power saving method for a microcontroller of claim 44, wherein said normal mode and said sleep mode, said normal mode and said idle mode, said slow mode and sleep mode, and said slow mode and said idle mode are switched by setting a second firmware control bit of said low power register and a halt command.

47. The power saving method for a microcontroller of claim 43, wherein said sleep mode and said idle mode start a wakeup mechanism via a wakeup signal to return to said normal mode or said slow mode.

48. The power saving method for a microcontroller of claim 36, further comprising a step of transmitting said fourth clock to a second peripheral through a third switch.

49. The power saving method for a microcontroller of claim 48, wherein said third switch is controlled by said execution unit based on said power saving mode and a switch control bit of said second peripheral.

50. The power saving method for a microcontroller of claim 36, further comprising a step of transmitting said third clock to a third peripheral through a fourth switch.

51. The power saving method for a microcontroller of claim 50, wherein said third clock has its frequency divided by a second frequency divider and transmitted to said third peripheral.

52. The power saving method for a microcontroller of claim 50, wherein said fourth switch is controlled by an execution unit based on said power saving mode.
